(19) United States
(12) Patent Application Publication
(10) Pub. No.: US 2026/0117667 A1
(43) Pub. Date: Apr. 30, 2026

(54) METHODS AND APPARATUS TO REDUCE VIBRATION OF A RADIAL SEAL IN A GAS TURBINE ENGINE

(71) Applicant: General Electric Company, Evendale, OH (US)

(72) Inventors: Prateek Jalan, Bengaluru (IN); Ravindra Shankar Ganiger, Bengaluru (IN); Steven Douglas Johnson, Milford, OH (US); Rahul A. Bidkar, Clifton Park, NY (US); David Yamarthi, Bengaluru (IN); Deepak Trivedi, Halfmoon, NY (US); Himanshu Gupta, Panchkula (IN); Hiranya Nath, Bengaluru (IN)

(21) Appl. No.: 19/296,593

(22) Filed: Aug. 11, 2025

(30) Foreign Application Priority Data
Oct. 30, 2024 (IN) 202411083093

(51) Int. Cl. F01D 11/08; F03G 7/06

(52) U.S. Cl. CPC F01D 11/08; F03G 7/0614; F05D 2260/96

(57) ABSTRACT

Methods and apparatus to reduce vibration of a radial seal in a gas turbine engine are disclosed. An example apparatus includes a seal segment of a radial seal positioned between a rotor and a stator of a gas turbine engine, the seal segment including a first seal body adjacent the rotor and a first surface of the stator, a second seal body adjacent a second surface of the stator, the second surface opposite the first surface, the second seal body pivotable relative to the first seal body, and a pivot bar extending between the first seal body and the second seal body, and a damper operatively coupled to the pivot bar.

### CROSS REFERENCE TO RELATED APPLICATIONS

The present application claims the benefit of Indian Patent Application number 202411083093, filed on Oct. 30, 2024, which is hereby incorporated by reference herein in its entirety.

### FIELD OF THE DISCLOSURE

This disclosure relates generally to sealing in gas turbine engines and, more particularly, to methods and apparatus to reduce vibration of a radial seal in a gas turbine engine.

### BACKGROUND

Gas turbine engines, such as turbofan engines, may be used for aircraft propulsion. A turbofan engine generally includes a bypass fan section and a turbomachine such as a gas turbine engine to drive the bypass fan. The turbomachine generally includes a compressor section, a combustion section, and a turbine section in a serial flow arrangement. The compressor section and the turbine section are driven by one or more rotor shafts and generally include multiple rows or stages of rotor blades coupled to the rotor shaft. A row of rotor blades is axially spaced from a successive row of rotor blades by a respective row of stator or stationary vanes. A radial gap is formed between an inner surface of the stator vanes and an outer surface of the rotor shaft.

### BRIEF DESCRIPTION OF THE DRAWINGS

FIG. 1 is a schematic cross-sectional view of an example high-bypass turbofan-type gas turbine engine in which examples disclosed herein may be implemented.

FIG. 2 is a cross-sectional view of an example radial seal that may be implemented in the example gas turbine engine of FIG. 1.

FIG. 3 is a cross-sectional view of an example seal segment of FIG. 2 taken along line A-A of FIG. 2.

FIG. 4 illustrates the example seal segment of FIG. 3 including an example opening to receive one or more example damper inserts.

FIG. 5A illustrates a first example damper insert that may be implemented in the opening of the pivot bar of FIG. 4.

FIG. 5B illustrates a second example damper insert that may be implemented in the opening of the pivot bar of FIG. 4.

FIG. 5C illustrates the second damper insert of FIG. 5B implementing an example bimetallic strip.

FIG. 5D illustrates a third example damper insert that may be implemented in the opening of the pivot bar of FIG. 4.

FIG. 6 illustrates a fourth example damper insert that may be implemented in the opening of the pivot bar of FIG. 4.

FIG. 7 illustrates a fifth example damper operatively coupled between first and second seal segments of FIG. 2.

In general, the same reference numbers will be used throughout the drawing(s) and accompanying written description to refer to the same or like parts. The figures are not necessarily to scale. Instead, the thickness of the layers or regions may be enlarged in the drawings. Although the figures show layers and regions with clean lines and boundaries, some or all of these lines and/or boundaries may be idealized. In reality, the boundaries and/or lines may be unobservable, blended, and/or irregular.

### DETAILED DESCRIPTION

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities, etc., the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities, etc., the phrase “at least one of A or B” is intended to refer to implementations including any of (1) at least one A, (2) at least one B, or (3) at least one A and at least one B.

As used herein, singular references (e.g., “a”, “an”, “first”, “second”, etc.) do not exclude a plurality. The term “a” or “an” object, as used herein, refers to one or more of that object. The terms “a” (or “an”), “one or more”, and “at least one” are used interchangeably herein. Furthermore, although individually listed, a plurality of means, elements, or actions may be implemented by, e.g., the same entity or object. Additionally, although individual features may be included in different examples or claims, these may possibly be combined, and the inclusion in different examples or claims does not imply that a combination of features is not feasible and/or advantageous.

As used herein, unless otherwise stated, the term “above” describes the relationship of two parts relative to Earth. A first part is above a second part, if the second part has at least one part between Earth and the first part. Likewise, as used herein, a first part is “below” a second part when the first part is closer to the Earth than the second part. As noted above, a first part can be above or below a second part with one or more of: other parts therebetween, without other parts therebetween, with the first and second parts touching, or without the first and second parts being in direct contact with one another.

As used in this patent, stating that any part (e.g., a layer, film, area, region, or plate) is in any way on (e.g., positioned on, located on, disposed on, or formed on, etc.) another part, indicates that the referenced part is either in contact with the other part, or that the referenced part is above the other part with one or more intermediate part(s) located therebetween.

As used herein, connection references (e.g., attached, coupled, connected, and joined) may include intermediate members between the elements referenced by the connection reference and/or relative movement between those elements unless otherwise indicated. As such, connection references do not necessarily infer that two elements are directly connected and/or in fixed relation to each other. As used herein, stating that any part is in “contact” with another part is defined to mean that there is no intermediate part between the two parts.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly within the context of the discussion (e.g., within a claim) in which the elements might, for example, otherwise share a same name.

As used herein, “approximately” and “about” modify their subjects/values to recognize the potential presence of variations that occur in real world applications. For example, “approximately” and “about” may modify dimensions that may not be exact due to manufacturing tolerances and/or other real world imperfections as will be understood by persons of ordinary skill in the art. For example, “substantially,” “approximately,” and “about” may indicate such dimensions may be within a tolerance range of +/−10% unless otherwise specified herein.

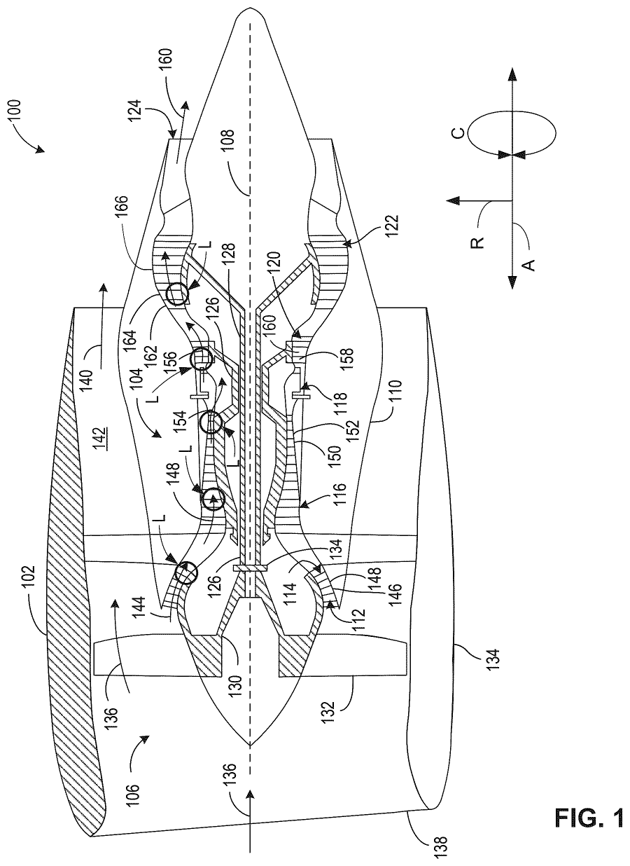

FIG. 1 is a schematic cross-sectional view of an example high-bypass turbofan-type gas turbine engine (“turbofan engine 100”) in which examples disclosed herein may be implemented. While the illustrated example is a high-bypass turbofan engine, the principles of the present disclosure are also applicable to other types of engines, such as low-bypass turbofans, turbojets, turboprops, etc. The turbofan engine 100 includes an outer bypass duct 104 (which may also be referred to as a nacelle, fan duct, or outer casing), a gas turbine engine 106 (which may also be referred to as a core turbine engine or turbo-machinery), and a fan section 108. The gas turbine engine 106 and the fan section 108 are disposed at least partially in the outer bypass duct 104. The gas turbine engine 106 is disposed downstream from the fan section 108 and drives the fan section 108 to produce forward thrust. As shown in FIG. 1, the turbofan engine 100 or the gas turbine engine 106 define a longitudinal or axial centerline axis 102 extending therethrough for reference. FIG. 1 also includes an annotated directional diagram with reference to an axial direction A, a radial direction R, and a circumferential direction C. In general, as used herein, the axial direction A is a direction that extends generally parallel to the axial centerline axis 102, the radial direction R is a direction that extends orthogonally outwardly from the axial centerline axis 102, and the circumferential direction C is a direction that extends concentrically around the axial centerline axis 102.

The gas turbine engine 106 includes an approximately tubular outer casing 110 (which may also be referred to as a mid-casing) that defines an annular inlet 112. The outer casing 110 of the gas turbine engine 106 can be formed from a single casing or a plurality of casings. The outer casing 110 encloses, in serial flow relationship, a compressor section having a booster or low pressure compressor 114 (“LP compressor 114”) and a high pressure compressor 116 (“HP compressor 116”), a combustion section 118, a turbine section having a high pressure turbine 120 (“HP turbine 120”) and a low pressure turbine 122 (“LP turbine 122”), and an exhaust section 124. A high pressure shaft or spool 126 (“HP shaft 126”) drivingly couples the HP turbine 120 and the HP compressor 116. A low pressure shaft or spool 128 (“LP shaft 128”) drivingly couples the LP turbine 122 and the LP compressor 114. The LP shaft 128 may also couple to a fan spool or shaft 130 of the fan section 108. In some examples, the LP shaft 128 may couple directly to the fan shaft 130 (i.e., a direct-drive configuration). In alternative configurations, the LP shaft 128 may couple to the fan shaft 130 via a reduction gearbox 132 (i.e., an indirect-drive or geared-drive configuration).

As shown in FIG. 1, the fan section 108 includes a plurality of fan blades 134 coupled to and extending radially outwardly from the fan shaft 130. The outer bypass duct 104 circumferentially encloses the fan section 108 or at least a portion of the gas turbine engine 106. In particular, the gas turbine engine is disposed in the outer bypass duct 104 such that a bypass airflow passage or duct 136 is formed between the outer casing 110 of the gas turbine engine 106 and the outer bypass duct 104. The outer bypass duct 104 may be supported relative to the gas turbine engine 106 by a plurality of circumferentially-spaced apart outlet guide vanes 138.

As illustrated in FIG. 1, during operation of the turbofan engine 100, air 140 enters an inlet portion 142 of the turbofan engine 100. The air 140 is accelerated by the fan blades 134. A first portion 144 of the air 140 flows into the bypass airflow passage 136, while a second portion 146 of the air 140 flows into the annular inlet 112 of the gas turbine engine 106 (and, thus, into the LP compressor 114). One or more sequential stages of LP compressor stator vanes 148 and LP compressor rotor blades 150 coupled to the LP shaft 128 progressively compress the second portion 146 of the air 140 flowing through the LP compressor 114 en route to the HP compressor 116. Next, one or more sequential stages of HP compressor stator vanes 152 and HP compressor rotor blades 154 coupled to the HP shaft 126 further compress the second portion 146 of the air 140 flowing through the HP compressor 116. This provides compressed air 156 to the combustion section 118 where it mixes with fuel and burns to provide combustion gases 158.

The combustion gases 158 flow through the HP turbine 120 where one or more sequential stages of HP turbine stator vanes 160 and HP turbine rotor blades 162 coupled to the HP shaft 126 extract a first portion of kinetic or thermal energy therefrom. This energy extraction supports operation of the HP compressor 116. The combustion gases 158 then flow through the LP turbine 122 where one or more sequential stages of LP turbine stator vanes 164 and LP turbine rotor blades 166 coupled to the LP shaft 128 extract a second portion of thermal or kinetic energy therefrom. This energy extraction causes the LP shaft 128 to rotate, which supports operation of the LP compressor 114 or rotation of the fan shaft 130. The combustion gases 158 then exit the gas turbine engine 106 through the exhaust section 124 thereof. The combustion gases 158 mix with the first portion 144 of the air 140 from the bypass airflow passage 136 to produce propulsive thrust.

Along with the turbofan engine 100, the gas turbine engine 106 serves a similar purpose and sees a similar environment in land-based gas turbines, turbojet engines in which the ratio of the first portion 144 of the air 140 to the second portion 146 of the air 140 is less than that of a turbofan, and unducted fan engines in which the fan section 108 is devoid of the outer bypass duct 104. In each of the turbofan, turbojet, and unducted engines, a speed reduction device (e.g., the reduction gearbox 132) may be included between any shafts and spools. For example, the reduction gearbox 132 may be disposed between the LP shaft 128 and the fan shaft 130 of the fan section 108.

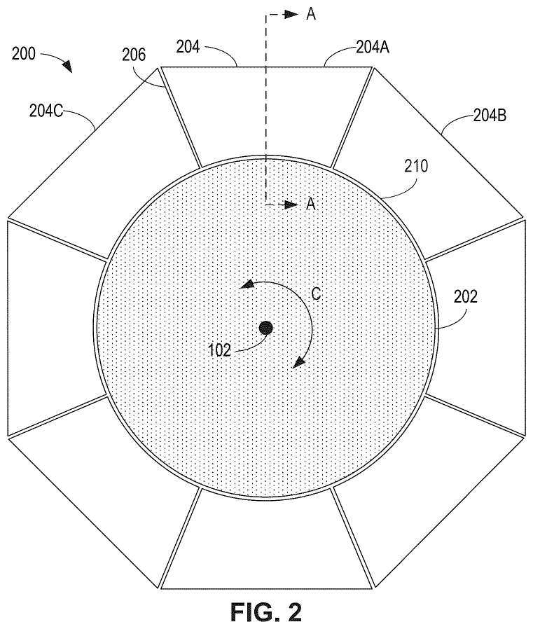

In some examples, one or more seals (e.g., radial seals, hybrid radial seals, film-riding seals, etc.) may be implemented in the gas turbine engine 106 to restrict flow and/or leakage of fluid between high-pressure and low-pressure regions of the gas turbine engine 106. For example, FIG. 2 is a cross-sectional view of an example radial seal (e.g., a hybrid radial seal, a segmented seal, a film-riding seal) 200 that may be implemented in the example gas turbine engine 106 of FIG. 1. In the illustrated example of FIG. 2, the radial seal 200 is implemented on and/or operatively coupled to an example rotor (e.g., a rotor shaft) 202. In some examples, the rotor 202 corresponds to a rotor of the gas turbine engine 106 of FIG. 1, such as the HP shaft 126, the LP shaft 128, etc. For example, referring back to FIG. 1, example locations (e.g., labelled L) at which the radial seal 200 of FIG. 2 may be implemented are shown in FIG. 1.

Returning to FIG. 2, the radial seal 200 includes multiple example seal segments (e.g., radial seal segments) 204 spaced about a circumference of the rotor 202. While the radial seal 200 includes eight of the seal segments 204 in this example, the radial seal 200 can include a different number (e.g., at least two, nine or more) of the seal segments 204 instead. In some examples, adjacent seal segments 204 (e.g., a first seal segment 204A and a second seal segment 204B, the first seal segment 204A and a third seal segment 204C, etc.) are coupled together at one or more locations along respective edges and/or side surfaces 206 of the seal segments 204. In some examples, the radial seal 200 can include gaps (e.g., inter-segment gaps) 208 between adjacent seal segments 204, and can further include a radial gap 210 between the seal segments 204 and the rotor 202.

In the illustrated example of FIG. 2, the radial seal 200 includes an example film (e.g., a gas film, an air film, a fluid bearing) 212 positioned in the radial gap 210 between the rotor 202 and the seal segments 204. In some examples, the film 212 enables rotation of the rotor 202 in the circumferential direction C about the axial centerline axis 102 of FIG. 1 (e.g., extending out of the page in FIG. 2) while restricting flow and/or leakage of fluid between a high-pressure region and a low-pressure region of the gas turbine engine 106 of FIG. 1. For example, the film 212 can maintain a separation between the rotor 202 and the seal segments 204 to reduce friction therebetween and, as a result, reduce wear of the seal segments 204 and/or the rotor 202 during operation of the gas turbine engine 106.

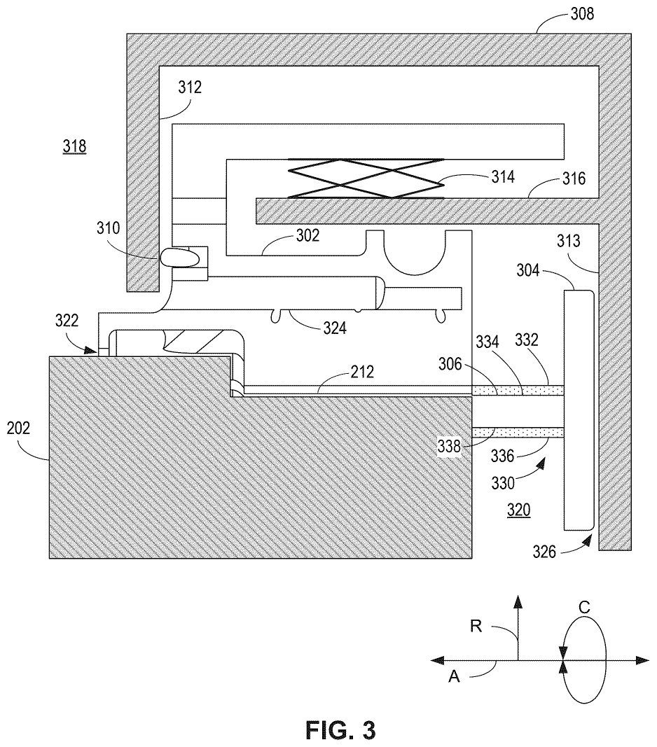

FIG. 3 is a cross-sectional view of one of the example seal segments 204 (e.g., the first seal segment 204A) of FIG. 2 taken along line A-A of FIG. 2. In the illustrated example of FIG. 3, the seal segment 204 includes a first example seal body (e.g., a radial body) 302, a second example seal body (e.g., an axial body) 304, and an example pivot bar 306 coupled and/or extending between the first seal body 302 and the second seal body 304. Further, an example stator (e.g., a carrier, a casing, a seal housing) 308 (a portion of which is shown in FIG. 3) is positioned proximate to and/or surrounding a portion of the seal segment 204. In this example, a piston bar (e.g., a piston damper, a secondary seal) 310 is positioned in the first seal body 302 and contacts a first surface 312 of the stator 308. Further, the second seal body 304 is adjacent and/or proximate to a second surface 313 of the stator 308 (e.g., opposite the first surface 312), and a spring 314 is operatively coupled between the seal segment 204 and a third surface 316 of the stator 308. In this example, the film 212 of FIG. 2 is positioned between the seal segment 204 and the rotor 202.

In the illustrated example of FIG. 3, the seal segment 204 restricts flow and/or leakage of fluid between a high-pressure region 318 and a low-pressure region 320 of the gas turbine engine 106 of FIG. 1. For example, during operation of the gas turbine engine 106 (e.g., during rotation of the rotor 202 in the circumferential direction C), fluid from the high-pressure region 318 can enter a gap 322 between the first seal body 302 and the rotor 202, where the film 212 restricts flow of the fluid and/or reduces a pressure of the fluid to the low-pressure region 320. Additionally, high-pressure fluid can flow into a feedhole 324 defined in the first seal body 302, where the fluid can further flow from the feedhole 324 to the film 212 via one or more fluid passageways (not shown) defined in the first seal body 302. In some examples, the high-pressure fluid entering the first seal body 302 (e.g., via the gap 322 and/or via the feedhole 324) results in a first radial force on the seal segment 204 (e.g., in the radial direction R of FIG. 3). Additionally, the spring 314 can apply a second radial force on the seal segment 204. In some examples, a combination of the first and second radial forces on the seal segment 204 results in a net radial force that enables the seal segment 204 to follow and/or ride on a surface of the rotating rotor 202 without contacting the rotor 202.

In the illustrated example of FIG. 3, an air bearing 326 is implemented between the second seal body 304 and the second surface 313 of the stator 308. In some examples, the air bearing 326 can restrict and/or prevent contact between the second seal body 304 and the stator 308, and/or can maintain an axial position of the seal segment 204 relative to the rotor 202. For example, fluid from the high-pressure region 318 can apply a first axial force on the seal segment 204 in a first axial direction (e.g., rightward in FIG. 3), and the air bearing 326 can apply a second axial force (e.g., a reactionary force) on the seal segment 204 in a second axial direction (e.g., leftward in FIG. 3) opposite the first axial direction. In some examples, a combination of the axial forces (e.g., a net axial force) on the seal segment 204 prevents and/or reduces contact between the second seal body 304 and the second surface 313 of the stator 308. As a result, the air bearing 326 can prevent and/or reduce jamming of the seal segment 204 in the radial direction R (e.g., jamming resulting from frictional contact between the second seal body 304 and the stator 308).

In some examples, vibration of the rotor 202 and/or the seal segment 204 may occur during operation of the gas turbine engine 106 of FIG. 1. For example, when the rotor 202 rotates in the circumferential direction C, the rotor 202 may expand (e.g., in the radial direction R) as a result of centrifugal growth and/or changes in temperature of the rotor 202. Additionally or alternatively, a radial dimension of the rotor 202 may vary in the circumferential direction C (e.g., as a result of manufacturing tolerances and/or misalignment between components of the gas turbine engine 106). In some examples, the first seal body 302 follows and/or rides on a surface of the rotor 202, and variations in the radial dimension of the rotor 202 may result in vibration of the first seal body 302 in the radial direction R (e.g., up and down in FIG. 3). In some such examples, when the first seal body 302 moves (e.g., vibrates) in the radial direction R, the pivot bar 306 enables the first seal body 302 to pivot with respect to the second seal body 304. In some examples, such pivoting and/or vibration of the first seal body 302 may result in undesired contact between the seal segment 204 and the rotor 202, which may cause damage to the rotor 202 and/or to one or more components of the gas turbine engine 106.

In some examples, in addition to providing a secondary seal between the high-pressure region 318 and the low-pressure region 320 (e.g., by restricting flow of fluid between the first seal body 302 and the first surface 312), the piston bar 310 can function as a damper to restrict and/or damp vibration of the first seal body 302. For example, friction between the piston bar 310 and the first surface 312 can oppose radial movement (e.g., movement in the radial direction R) of the first seal body 302 to damp and/or dissipate the vibration. In some examples, insufficient damping by the piston bar 310 (e.g., damping that is less than or greater than a threshold) can adversely affect sealing performance of the radial seal 200. For example, when the piston bar 310 excessively damps the radial movement of the first seal body 302 (e.g., when the damping is above a threshold), resulting force and/or moment imbalances on the seal segment 204 may result in insufficient sealing between the seal segment 204 and the rotor 202. Conversely, when the piston bar 310 does not sufficiently damp the radial movement of the first seal body 302 (e.g., when the damping is less than the threshold), excessive vibration of the seal segment 204 may result in undesired contact between, and, thus, damage to, the seal segment 204 and/or the rotor 202.

Examples disclosed herein can reduce (e.g., damp, dissipate) vibration of the first seal body 302 (e.g., relative to the rotor 202 and/or the second seal body 304) to prevent and/or reduce undesired contact between the rotor 202 and the seal segment 204. Further, by reducing vibration of the seal segment 204, examples disclosed herein enable the seal segment 204 to more closely follow (e.g., align with, match, etc.) a surface of the rotating rotor 202 and, as a result, can improve sealing performance of the seal segment 204. In the illustrated example of FIG. 3, the seal segment 204 includes a first example damper (e.g., a damper coating, a viscoelastic coating) 330 to reduce (e.g., damp) vibratory loads applied to the seal segment 204 from the rotor 202.

In the example of FIG. 3, the first damper 330 includes one or more material layers (e.g., coatings) coupled to one or more surfaces of the pivot bar 306. In the example of FIG. 3, the first damper 330 includes a first material layer (e.g., a first coating) 332 on an outer surface 334 of the pivot bar 306, and further includes a second material layer (e.g., a second coating) 336 on an inner surface 338 of the pivot bar 306. In some examples, one of the first material layer 332 or the second material layer 336 may be omitted. In some examples, a thickness of the first material layer 332 and/or the second material layer 336 is at least 0.001 inches and up to and including 0.1 inches. In some examples, the thickness of the first material layer 332 and/or the second material layer 336 is up to 20 percent (%) of a thickness of the pivot bar 306 (e.g., the thickness between the inner surface 338 and the outer surface 334 of the pivot bar 306).

In the illustrated example of FIG. 3, the first damper 330 can include at least one of a metallic composite material or a polymer material. For example, the metallic composite material can include at least one of aluminum, titanium, or nickel. Further, in some examples, the metallic composite material includes (e.g., is reinforced with) one or more secondary materials, where the secondary material(s) can include at least one of silicon carbide, aluminum oxide, or carbon fiber. In some examples, the secondary material(s) correspond to fibers and/or particles that are mixed into and/or substantially evenly distributed throughout the metallic composite material. In some examples, the polymer material used for the first damper 330 can include polybenzimidazole (PBI) when temperatures at the radial seal 200 are expected to be at or below 1292 degrees Fahrenheit (° F.).

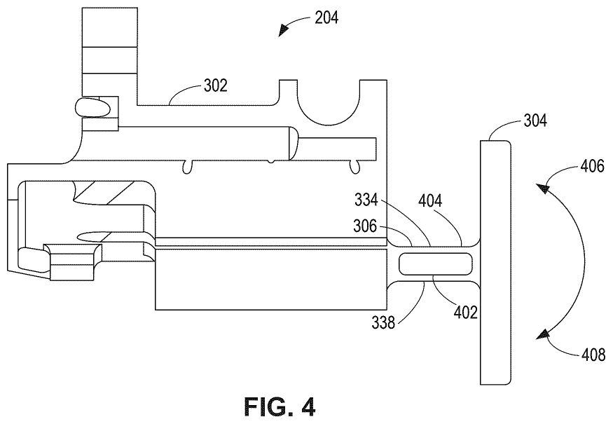

FIG. 4 illustrates the example seal segment 204 of FIG. 3 including an example opening (e.g., a cavity) 402 to receive one or more example dampers (e.g., damper inserts). In the illustrated example of FIG. 4, the stator 308 and the rotor 202 of FIG. 3 are omitted for clarity, and the seal segment 204 of FIG. 4 does not implement the first damper 330 of FIG. 3. Instead, one or more different dampers (e.g., damper inserts) can be positioned in the opening 402 and/or coupled to the pivot bar 306 to reduce (e.g., damp, dissipate) vibratory loads on the seal segment 204. In the illustrated example of FIG. 4, the opening 402 is positioned in and/or extends into a side surface 404 of the pivot bar 306. In some examples, the opening 402 is a through-hole extending a width of the pivot bar 306 (e.g., into and/or out of the page in FIG. 4). In some examples, the opening 402 extends partially into the pivot bar 306 from the side surface 404 (e.g., extends less than the width of the pivot bar 306). In this example, the opening 402 is substantially rectangular with rounded corners. In some examples, a shape of the opening 402 may be different.

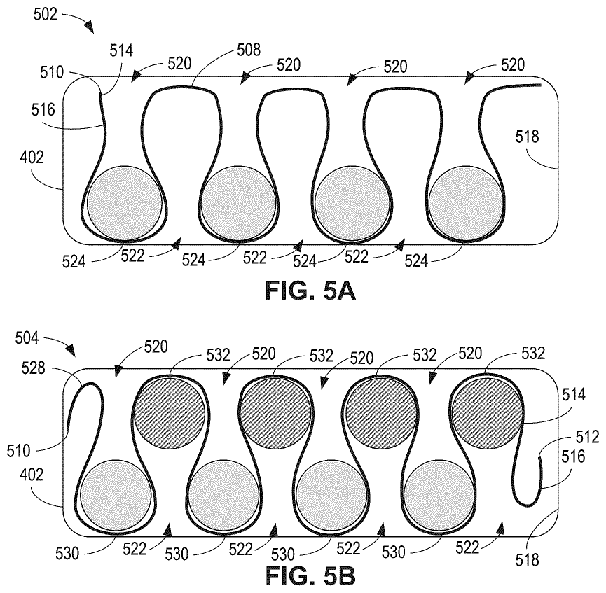

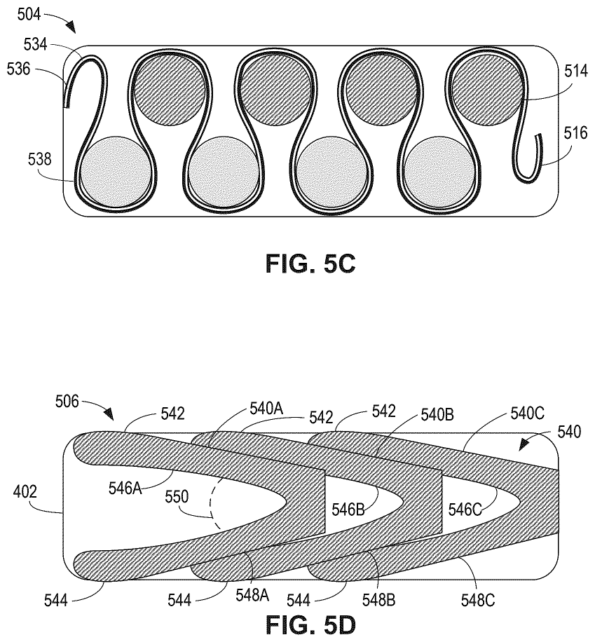

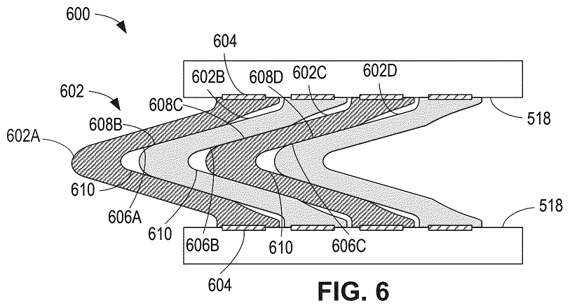

In some examples, when the second seal body 304 and/or the pivot bar 306 of FIG. 4 pivot relative to the first seal body 302 (e.g., as a result of vibratory loads to the seal segment 204), angular displacement between the first and second seal bodies 302, 304 results in tension and/or compression on one or more surfaces and/or in one or more portions of the pivot bar 306. For example, as a result of the second seal body 304 pivoting in a first direction 406 (e.g., a counterclockwise direction of FIG. 4) relative to the first seal body 302, a first portion of the pivot bar 306 (e.g., at or near the outer surface 334 of the pivot bar 306) may be compressed, and a second portion of the pivot bar 306 (e.g., at or near the inner surface 338 of the pivot bar 306) may be in tension. Conversely, as a result of the second seal body 304 pivoting in a second direction 408 (e.g., a clockwise direction of FIG. 4) relative to the first seal body 302, the first portion of the pivot bar 306 (e.g., at or near the outer surface 334) may be in tension, and the second portion of the pivot bar 306 (e.g., at or near the inner surface 338) may be compressed. In some examples, one or more dampers (e.g., damper inserts) may be positioned in the opening 402 to oppose tension and/or compression of the pivot bar 306 and, as a result, reduce (e.g., damp, dissipate) vibratory loads on the seal segment 204. Example damper inserts that may be positioned and/or implemented in the opening 402 are discussed below in connection with FIGS. 5A, 5B, 5C, and 5D.

FIGS. 5A, 5B, and 5D illustrate an example first damper insert 502, an example second damper insert 504, and an example third damper insert 506, respectively, that may be implemented (e.g., positioned) in the opening 402 of the pivot bar 306 of FIG. 4. Turning to FIG. 5A, the first damper insert 502 includes an example curved strip 508 positioned in the opening 402. The curved strip 508 includes a first end 510, a second end 512, a first surface 514 extending between the first and second ends 510, 512, and a second surface 516 opposite the first surface 514. In this example, the second end 512 of the curved strip 508 is coupled (e.g., fixedly coupled) to an inner surface 518 of the opening 402, and the first end 510 can move relative to the second end 512. In some examples, both the first end 510 and the second end 512 can be fixed (e.g., fixedly coupled to respective locations of the inner surface 518). In some examples, the first end 510 and the second end 512 are not fixed and/or coupled to the inner surface 518 of the opening 402, such that the curved strip 508 can move freely within the opening 402.

In the illustrated example of FIG. 5A, the first and second surfaces 514, 516 define example concavities (e.g., alternating concavities) 520, 522 of the curved strip 508. For example, the first surface 514 defines a plurality of first example concavities (e.g., first curved surfaces) 520 between the first and second ends 510, 512 of the curved strip 508. Further, the second surface 516 defines a plurality of second example concavities (e.g., second curved surfaces) 522 between the first and second ends 510, 512 of the curved strip 508, where the second concavities 522 are positioned between and/or adjacent to the respective first concavities 520. In the illustrated example of FIG. 5A, the curved strip 508 includes four of the first concavities 520 and three of the second concavities 522. In some examples, the number of the first concavities 520 and/or the second concavities 522 may be different (e.g., five or more, two or less, etc.). Further, while the concavities 520, 522 are rounded and/or partially circular in this example, a shape of the concavities 520, 522 may be different in some examples. For example, one or more of the concavities 520, 522 can include corners, flat (e.g., uncurved) portions, etc.

In the illustrated example of FIG. 5A, the first damper insert 502 includes example cylindrical members 524 positioned in the respective first concavities 520. In some examples, the cylindrical members 524 can include an elastic material and/or a viscoelastic high-friction material. In this example, the cylindrical members 524 have a circular cross-sectional shape that at least partially corresponds to a curvature of the first concavities 520. In some examples, a cross-sectional shape of the cylindrical members 524 may be different (e.g., elliptical, hexagonal, etc.). In some examples, a radius of the cylindrical members 524 can be at least 0.02 inches and up to 0.1 inches, and a length of the cylindrical members 524 can be at least 0.02 inches and up to 1 inch. In some examples, one or more spherical members (e.g., elastic spherical members) can be used in addition to or instead of the cylindrical members 524.

In some examples, when the second seal body 304 is pivoted (e.g., in the first direction 406 or the second direction 408 of FIG. 4) relative to the first seal body 302, the first damper insert 502 flexes and opposes tension and/or compression of the pivot bar 306. Accordingly, the first damper insert 502 can bias the pivot bar 306 and/or the second seal body 304 to a substantially unpivoted position relative to the first seal body 302. For example, when the second seal body 304 is pivoted in the first direction 406 relative to the first seal body 302, the resulting tension and/or compression on the pivot bar 306 can cause the first concavities 520 to narrow and/or close, and can further cause the second concavities 522 to widen and/or open (e.g., responsive to flexion of the curved strip 508). In some such examples, as a result of the narrowing of the first concavities 520, the first surface 514 of the curved strip 508 may compress the cylindrical members 524. The compressed cylindrical members 524 oppose the compressive forces to bias and/or return the curved strip 508 to a starting (e.g., unflexed) position and, thus, bias the pivot bar 306 and/or the second seal body 304 to the unpivoted position of FIG. 4.

FIG. 5B illustrates the example second damper insert 504 that may be implemented in the opening 402 of the pivot bar 306 of FIG. 4. In the illustrated example of FIG. 5B, the second damper insert 504 includes an example second curved strip 528 positioned in the opening 402. In this example, the second curved strip 528 is substantially the same as the curved strip 508 of the first damper insert 502 of FIG. 5A and, as such, the same reference numbers are used to refer to the same or similar parts of the curved strip 508 of FIG. 5A and the second curved strip 528 of FIG. 5B. However, while three of the second concavities 522 are shown in FIG. 5A, the second curved strip 528 of FIG. 5B includes four of the second concavities 522. Accordingly, the second curved strip 528 includes the same number (e.g., four) of the second concavities 522 as the first concavities 520. In some examples, at least one of the first end 510 or the second end 512 of the second curved strip 528 is coupled (e.g., fixedly coupled) to the inner surface 518 of the opening 402.

In the illustrated example of FIG. 5B, the second damper insert 504 includes example first cylindrical members 530 positioned in respective first concavities 520, and example second cylindrical members 532 positioned in respective second concavities 522. In this example, the first cylindrical members 530 and the second cylindrical members 532 have substantially the same shape and/or dimensions (e.g., radius, length, etc.), but can be different materials and/or have different material properties. For example, the first cylindrical members 530 can include a first material having a first stiffness, and the second cylindrical members 532 can include a second material having a second stiffness less than the first stiffness. In some examples, a first dimension (e.g., a radius) of the first cylindrical members 530 may be different (e.g., smaller, greater) than a corresponding second dimension of the second cylindrical members 532.

In some examples, when the second seal body 304 of FIG. 4 is pivoted (e.g., in the first direction 406 or the second direction 408 of FIG. 4) relative to the first seal body 302, the second damper insert 504 opposes tension and/or compression of the pivot bar 306 to bias the pivot bar 306 and/or the second seal body 304 to the substantially unpivoted position of FIG. 4. For example, when the second seal body 304 is pivoted in the first (e.g., counterclockwise) direction 406 of FIG. 4 (e.g., relative to the first seal body 302), the resulting tension and/or compression on the pivot bar 306 can cause the first concavities 520 to narrow and/or close, and can further cause the second concavities 522 to widen and/or open (e.g., responsive to flexion of the second curved strip 528). In some such examples, as a result of the narrowing of the first concavities 520, the first surface 514 of the second curved strip 528 compresses the first cylindrical members 530. The compressed first cylindrical members 530 oppose the compressive forces to bias and/or return the second curved strip 528 to a starting (e.g., unflexed) position and, thus, bias the pivot bar 306 and/or the second seal body 304 to the unpivoted position of FIG. 4.

Conversely, when the second seal body 304 is pivoted in the second (e.g., clockwise) direction 408 of FIG. 4 (e.g., relative to the first seal body 302), the resulting tension and/or compression on the pivot bar 306 can cause the first concavities 520 to widen and/or open, and can further cause the second concavities 522 to narrow and/or close. In some such examples, as a result of the narrowing of the second concavities 522, the second surface 516 of the second curved strip 528 compresses the second cylindrical members 532. The compressed second cylindrical members 532 oppose the compressive forces to bias and/or return the second curved strip 528 to a starting (e.g., unflexed) position and, thus, bias the pivot bar 306 and/or the second seal body 304 to the unpivoted position of FIG. 4.

In some examples, the curved strip 508 of FIG. 5A and/or the second curved strip 528 of FIG. 5B includes a shape memory alloy. Additionally or alternatively, the curved strip 508 of FIG. 5A and/or the second curved strip 528 of FIG. 5B can be a bimetallic strip. For example, FIG. 5C illustrates the second damper insert 504 of FIG. 5B implementing an example bimetallic strip (e.g., a curved bimetallic strip) 534 (e.g., instead of the second curved strip 528 of FIG. 5B). In this example, the bimetallic strip 534 has substantially the same shape as the second curved strip 528 of FIG. 5B and, as such, the same reference numbers are used to refer to the same or similar parts of the bimetallic strip 534 of FIG. 5C and the second curved strip 528 of FIG. 5B.

In the illustrated example of FIG. 5C, the bimetallic strip 534 includes a first metallic layer 536 coupled to a second metallic layer 538, where the first metallic layer 536 defines the first surface 514 and the second metallic layer 538 defines the second surface 516. In some examples, the first metallic layer 536 includes a first metallic material having a first coefficient of thermal expansion, and the second metallic layer 538 includes a second metallic material having a second coefficient of thermal expansion (e.g., less than and/or greater than the first coefficient of thermal expansion). In some such examples, as a result of heating of the bimetallic strip 534 (e.g., during operation of the gas turbine engine 106 of FIG. 1), the difference in thermal expansion between the first and second metallic layers 536, 538 may result in flexion and/or deformation of the bimetallic strip 534. In such examples, the bending and/or deformation of the bimetallic strip 534 may resist and/or oppose pivoting between the first and second seal bodies 302, 304 and, as a result, may bias the first and second seal bodies 302, 304 to the unpivoted configuration shown in FIG. 4. While the bimetallic strip 534 shown in FIG. 5C is implemented in the second damper insert 504 of FIG. 5B, the bimetallic strip 534 can be similarly implemented in the first damper insert 502 of FIG. 5A (e.g., instead of the curved strip 508 of FIG. 5A).

FIG. 5D illustrates the example third damper insert 506 that may be implemented in the opening 402 of the pivot bar 306 of FIG. 4. In the illustrated example of FIG. 5D, the third damper insert 506 includes a plurality of example curved strips 540 positioned in the opening 402. For example, three of the curved strips 540 (e.g., including a first curved strip 540A, a second curved strip 540B, and a third curved strip 540C) are positioned in the opening 402, with respective ends 542, 544 of the curved strips 540 coupled to the inner surface 518. In the illustrated example of FIG. 5D, the curved strips 540 are hairpin-shaped and/or wishbone-shaped, and the curved strips 540 include corresponding example concave surfaces 546A, 546B, 546C and corresponding example convex surfaces 548A, 548B, 548C opposite the respective concave surfaces 546A, 546B, 546C. In this example, the curved strips 540 are positioned adjacent to one another in the opening 402. For example, the first curved strip 540A is positioned adjacent to the second curved strip 540B such that the convex surface 548A of the first curved strip 540A contacts (e.g., engages) at least a portion of the concave surface 546B of the second curved strip 540B. Further, the second curved strip 540B is positioned adjacent to the third curved strip 540C such that the convex surface 548B of the second curved strip 540B contacts (e.g., engages) at least a portion of the concave surface 546C of the third curved strip 540C. In some examples, the convex surface 548C of the third curved strip 540C contacts and/or is fixedly coupled to the inner surface 518 of the opening 402. While the third damper insert 506 includes three of the curved strips 540 in FIG. 5D, a different number (e.g., less than three, four or more, etc.) of the curved strips 540 may be used instead.

In some examples, when the second seal body 304 of FIG. 4 is pivoted (e.g., in the first direction 406 or the second direction 408 of FIG. 4) relative to the first seal body 302, the third damper insert 506 opposes tension and/or compression of the pivot bar 306 to bias the pivot bar 306 and/or the second seal body 304 to the substantially unpivoted position of FIG. 4. For example, when the second seal body 304 is pivoted (e.g., relative to the first seal body 302), the resulting tension and/or compression on the pivot bar 306 can cause the curved strips 540 to narrow and/or close. For example, the curved strips 540 narrow when an angle 550 between respective ends 542, 544 decreases, and the curved strips 540 open and/or widen when the angle 550 increases. In some examples, the curved strips 540 oppose narrowing and/or opening of the curved strips 540 to bias the second seal body 304 to a substantially unpivoted position. Further, during narrowing and/or opening of the curved strips 540, friction (e.g., sliding friction) between contacting surfaces (e.g., the first convex surface 548A and the second concave surface 546B, the second convex surface 548B and the third concave surface 546C, etc.) may result from relative motion of adjacent curved strips 540, which can further dampen and/or dissipate vibratory loads on the radial seal 200.

FIG. 6 illustrates a fourth example damper insert 600 that may be implemented in the opening 402 of the pivot bar 306 of FIG. 4. The fourth damper insert 600 is similar to the third damper insert 506 of FIG. 5D, but includes four example curved strips 602 (e.g., a first curved strip 602A, a second curved strip 602B, a third curved strip 602C, and a fourth curved strip 602D) coupled to the inner surface 518 of the opening 402 of FIG. 4. In the illustrated example of FIG. 6, the curved strips 602 are coupled to the inner surface 518 via example shear fuse connections 604. In such examples, the shear fuse connections 604 fixedly couple respective ends of the curved strips 602 to the inner surface 518. When vibratory loads on the radial seal 200 exceed a threshold (e.g., when a pivot angle between the first and second seal bodies 302, 304 exceeds an angular threshold), one or more of the shear fuse connections 604 may break and/or rupture such that the respective ends of the curved strips 602 become disconnected from (e.g., not fixedly coupled to) the inner surface 518. In some examples, by enabling the curved strips 602 to disconnect from the inner surface 518, the shear fuse connections 604 can reduce and/or prevent damage to the seal segment 204 when the radial seal 200 is subject to excessive vibratory loads.

In the illustrated example of FIG. 6, different materials may be used for different and/or alternating curved strips 602. For example, the first and third curved strips 602A, 602C include a first example material (e.g., a first metallic material), and the second and fourth curved strips 602B, 602D include a second example material (e.g., a second metallic material) different from the first material. In some examples, the first material can have a different stiffness and/or a different coefficient of thermal expansion compared to the second material. In some examples, the curved strips 602 can have a variable stiffness (e.g., as a result of varying geometry and/or shape) across a length and/or width of the curved strips 602. In some examples, the first material and/or the second material includes a shape memory alloy (SMA) and/or a functionally graded material (FGM).

In the illustrated example of FIG. 6, the curved strips 602 contact at least a portion of adjacent one(s) of the curved strips 602. For example, a first concave surface 606A of the first curved strip 602A contacts a second convex surface 608B of the second curved strip 602B, a second concave surface 606B of the second curved strip 602B contacts a third convex surface 608C of the third curved strip 602C, and a third concave surface 606C of the third curved strip 602C contacts a fourth convex surface 608D of the fourth curved strip 602D. In some examples, sliding friction between contacting surfaces (e.g., the concave surfaces 606A, 606B, 606C and the corresponding convex surfaces 608B, 608C, 608D) can facilitate damping of vibratory loads on the seal segment 204 of FIG. 4. Further, in this example, the fourth damper insert 600 includes example cavities (e.g., air-filled cavities) 610 between adjacent curved strips 602. In some examples, the cavities 610 can be air-filled, and/or can include an example elastic material positioned in the cavities 610. In some examples, as a result of narrowing and/or bending of the curved strips 602, the material (e.g., the air and/or the elastic material) in the cavities 610 can be compressed to absorb and/or oppose forces on the curved strips 602 (e.g., the forces resulting from vibratory loads on the seal segment 204).

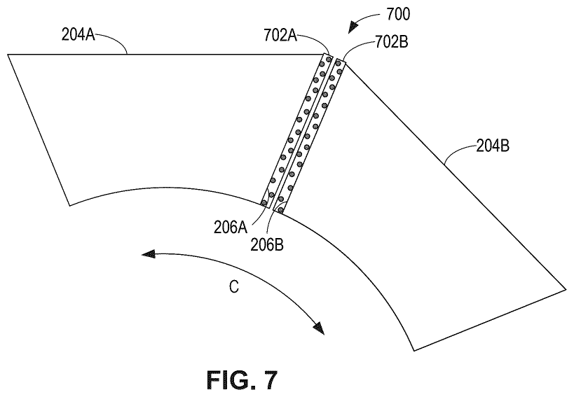

FIG. 7 illustrates the first seal segment 204A and the second seal segment 204B of FIG. 2, including a fifth example damper 700 operatively coupled between the seal segments 204A, 204B. In the illustrated example of FIG. 7, the fifth damper 700 includes a first example damper coating (e.g., a first viscoelastic coating) 702A coupled to a first side surface 206A of the first seal segment 204A, and a second example damper coating (e.g., a second viscoelastic coating) 702B coupled to a second side surface 206B of the second seal segment 204B, where the first side surface 206A is adjacent to and/or faces the second side surface 206B.

In the example of FIG. 7, the first and second damper coatings 702A, 702B can include a ceramic-based oxide coating. For example, the first and second damper coatings 702A, 702B can include a MCrAlX coating, where M represents a metal, Cr represents chromium, Al represents aluminum, and X represents one or more additional materials and/or chemicals. In some examples, the MCrAlX coating includes a first coating including nickel, chromium, aluminum, and yttrium (e.g., a NiCrAlY coating), and further includes a second coating (e.g., a top coating) including zirconium, oxygen, and yttrium (e.g., a ZrO₂—Y₂O₃ coating) coupled to the first coating. In some examples, one or more different materials and/or composites can be utilized for the first damper coating 702A and/or the second damper coating 702B. In some examples, the fifth damper 700 can include at least one of a bimetallic material, a shape memory alloy, a functionally graded material, graphene, or a graphite-like carbon (GLC) material coupled to at least one of the first side surface 206A or the second side surface 206B.

In some examples, the first and second damper coatings 702A, 702B are provided (e.g., deposited) on the respective side surfaces 206A, 206B using at least one of a thermal spray process, a cold spray process, or a slurry-based processed followed by a thermal spray process. In some examples, a porosity of the damper coatings 702A, 702B may be adjusted by adjusting the type(s) of materials used and/or by adjusting one or more parameters of a fabrication and/or deposition process for the damper coatings 702A, 702B. For example, increasing the porosity of the damper coatings 702A, 702B can improve damping and/or dissipation of vibratory loads by the fifth damper 700. Further, in some examples, additive manufacturing may be used to provide and/or deposit the damper coatings 702A, 702B on the respective side surfaces 206A, 206B. In some such examples, the resulting damper coatings 702A, 702B can have directionally dependent material properties. For example, the damper coatings 702A, 702B can have different material properties (e.g., elasticity, stiffness, etc.) along the axial, circumferential, and radial directions of FIG. 1.

In some examples, the radial seal 200 of FIG. 2 can implement any suitable combination of example dampers disclosed herein (e.g., the first damper 330 of FIG. 3, the first damper insert 502 of FIG. 5A, the second damper insert 504 of FIGS. 5B and/or 5C, the third damper insert 506 of FIG. 5D, the fourth damper insert 600 of FIG. 6, and/or the fifth damper 700 of FIG. 7) to reduce vibratory loads during operation of the gas turbine engine 106 of FIG. 1. For example, one or more of the dampers may be implemented in one or more of the seal segments 204 of FIG. 2, and the same or different combinations of the dampers can be used for different seal segments 204. In some examples, means for damping can be implemented by the first damper 330 of FIG. 3, the first damper insert 502 of FIG. 5A, the second damper insert 504 of FIGS. 5B and/or 5C, the third damper insert 506 of FIG. 5D, the fourth damper insert 600 of FIG. 6, and/or the fifth damper 700 of FIG. 7. In some examples, one or more dampers are selected for use in the gas turbine engine 106 of FIG. 1 based on operating conditions (e.g., expected vibration levels) of the gas turbine engine 106.

From the foregoing, it will be appreciated that example systems, apparatus, articles of manufacture, and methods have been disclosed that reduce (e.g., damp, dissipate) vibration of a radial seal (e.g., a hybrid radial seal) in a gas turbine engine. Examples disclosed herein can include an example damping material coating on one or more surfaces of the radial seal. The surface(s) can correspond to a surface of a pivot bar extending between a first seal body (e.g., a radial body) and a second seal body (e.g., an axial body) of a seal segment of the radial seal, and/or can correspond to side surface(s) between adjacent seal segments. In some examples, the damping material coating can include at least one of a metallic composite material, a polymer, or a ceramic material to oppose and/or absorb vibratory loads on one or more seal segments. Additionally or alternatively, examples disclosed herein can provide one or more example damper inserts in an opening of the pivot bar, where the damper inserts can oppose pivoting between the first and second seal bodies to damp and/or dissipate the vibratory loads. By reducing vibration of one or more seal segments (and/or portions thereof), examples disclosed herein enable the seal segment(s) to more closely follow a surface of the rotor during operation and, as a result, may improve sealing performance of the radial seal. Further, examples disclosed herein can reduce undesired contact between components of the gas turbine engine (e.g., between the rotor and one or more seal segments) and, thus, can reduce a likelihood of damage to one or more of the components during operation of the gas turbine engine. Disclosed systems, apparatus, articles of manufacture, and methods are accordingly directed to one or more improvement(s) in the operation of a machine and/or mechanical device.

Further disclosure is provided by the following clauses:

An apparatus, comprising a seal segment of a radial seal positioned between a rotor and a stator of a gas turbine engine, the seal segment including a first seal body adjacent the rotor and a first surface of the stator, a second seal body adjacent a second surface of the stator, the second surface opposite the first surface, the second seal body pivotable relative to the first seal body, and a pivot bar extending between the first seal body and the second seal body, and a damper operatively coupled to the pivot bar.

The apparatus of any preceding clause, wherein the damper includes a coating coupled to a third surface of the pivot bar, the coating including at least one of a polymer or a metallic composite material.

The apparatus of any preceding clause, wherein the polymer includes polybenzimidazole.

The apparatus of any preceding clause, wherein the metallic composite material includes at least one of aluminum, titanium, or nickel.

The apparatus of any preceding clause, wherein the metallic composite material includes at least one of silicon carbide, aluminum oxide, or carbon fiber.

The apparatus of any preceding clause, wherein the damper includes a curved strip positioned in an opening of the pivot bar, the curved strip to flex responsive to movement of the second seal body relative to the first seal body.

The apparatus of any preceding clause, wherein at least one end of the curved strip is fixedly coupled to an inner surface of the pivot bar, the inner surface defining the opening.

The apparatus of any preceding clause, wherein the curved strip includes a first metallic layer coupled to a second metallic layer, a first stiffness of the first metallic layer greater than a second stiffness of the second metallic layer.

The apparatus of any preceding clause, wherein the curved strip includes a third surface and a fourth surface opposite the third surface, the third surface defining a first concavity, the fourth surface defining a second concavity adjacent the first concavity.

The apparatus of any preceding clause, wherein the damper further includes a cylindrical member positioned in the first concavity, the cylindrical member to oppose flexion of the curved strip.

The apparatus of any preceding clause, wherein the cylindrical member is a first cylindrical member, further including a second cylindrical member positioned in the second concavity, the first cylindrical member including a first material having a first stiffness, the second cylindrical member including a second material having a second stiffness, the first stiffness greater than the second stiffness.

The apparatus of any preceding clause, wherein the curved strip is a first curved strip, further including a second curved strip positioned adjacent the first curved strip in the opening of the pivot bar, a convex surface of the second curved strip to contact a concave surface of the first curved strip, the contact between the convex surface and the concave surface to provide frictional damping responsive to flexion of the first curved strip and the second curved strip.

The apparatus of any preceding clause, wherein the first curved strip includes a first metallic material, the second curved strip includes a second metallic material different from the first metallic material.

The apparatus of any preceding clause, wherein at least one of the first curved strip or the second curved strip includes a shape memory alloy.

The apparatus of any preceding clause, further including an air-filled cavity defined between the concave surface of the first curved strip and the convex surface of the second curved strip.

The apparatus of any preceding clause, wherein the seal segment is a first seal segment, further including a second seal segment coupled to the first seal segment, a first side surface of the first seal segment adjacent a second side surface of the second seal segment, and a damping material coating coupled to at least one of the first side surface or the second side surface.

The apparatus of any preceding clause, wherein the damping material coating includes a ceramic material.

A gas turbine engine comprising a rotor, a stator, a radial seal segment positioned between the rotor and the stator, and a damping material coating coupled to a surface of the radial seal segment.

The gas turbine engine of any preceding clause, wherein the surface is a first surface, the radial seal segment including a first seal body adjacent the rotor and a second surface of the stator, a second seal body adjacent a third surface of the stator, the third surface opposite the second surface, the second seal body pivotable relative to the first seal body, and a pivot bar extending between the first seal body and the second seal body, the pivot bar including the first surface.

The gas turbine engine of any preceding clause, wherein the radial seal segment is a first radial seal segment, further including a second radial seal segment positioned between the rotor and the stator and coupled to the first radial seal segment, the surface corresponding to at least one of a first surface of the first radial seal segment or a second surface of the second radial seal segment, the first surface adjacent the second surface.

The following claims are hereby incorporated into this Detailed Description by this reference. Although certain example systems, apparatus, articles of manufacture, and methods have been disclosed herein, the scope of coverage of this patent is not limited thereto. On the contrary, this patent covers all systems, apparatus, articles of manufacture, and methods fairly falling within the scope of the claims of this patent.

1. An apparatus, comprising:
a seal segment of a radial seal positioned between a rotor and a stator of a gas turbine engine, the seal segment including:
a first seal body adjacent the rotor and a first surface of the stator;
a second seal body adjacent a second surface of the stator, the second surface opposite the first surface, the second seal body pivotable relative to the first seal body;
a pivot bar extending between the first seal body and the second seal body; and
a damper operatively coupled to the pivot bar.

2. The apparatus of claim 1, wherein the damper includes a coating coupled to a third surface of the pivot bar, the coating including at least one of a polymer or a metallic composite material.

3. The apparatus of claim 2, wherein the polymer includes polybenzimidazole.

4. The apparatus of claim 2, wherein the metallic composite material includes at least one of aluminum, titanium, or nickel.

5. The apparatus of claim 4, wherein the metallic composite material includes at least one of silicon carbide, aluminum oxide, or carbon fiber.

6. The apparatus of claim 1, wherein the damper includes a curved strip positioned in an opening of the pivot bar, the curved strip to flex responsive to movement of the second seal body relative to the first seal body.

7. The apparatus of claim 6, wherein at least one end of the curved strip is fixedly coupled to an inner surface of the pivot bar, the inner surface defining the opening.

8. The apparatus of claim 6, wherein the curved strip includes a first metallic layer coupled to a second metallic layer, a first stiffness of the first metallic layer greater than a second stiffness of the second metallic layer.

9. The apparatus of claim 6, wherein the curved strip includes a third surface and a fourth surface opposite the third surface, the third surface defining a first concavity, the fourth surface defining a second concavity adjacent the first concavity.

10. The apparatus of claim 9, wherein the damper further includes a cylindrical member positioned in the first concavity, the cylindrical member to oppose flexion of the curved strip.

11. The apparatus of claim 10, wherein the cylindrical member is a first cylindrical member, further including a second cylindrical member positioned in the second concavity, the first cylindrical member including a first material having a first stiffness, the second cylindrical member including a second material having a second stiffness, the first stiffness greater than the second stiffness.

12. The apparatus of claim 6, wherein the curved strip is a first curved strip, further including a second curved strip positioned adjacent the first curved strip in the opening of the pivot bar, a convex surface of the second curved strip to contact a concave surface of the first curved strip, the contact between the convex surface and the concave surface to provide frictional damping responsive to flexion of the first curved strip and the second curved strip.

13. The apparatus of claim 12, wherein the first curved strip includes a first metallic material, the second curved strip includes a second metallic material different from the first metallic material.

14. The apparatus of claim 12, wherein at least one of the first curved strip or the second curved strip includes a shape memory alloy.

15. The apparatus of claim 12, further including an air-filled cavity defined between the concave surface of the first curved strip and the convex surface of the second curved strip.

16. The apparatus of claim 1, wherein the seal segment is a first seal segment, further including:
a second seal segment coupled to the first seal segment, a first side surface of the first seal segment adjacent a second side surface of the second seal segment; and
a damping material coating coupled to at least one of the first side surface or the second side surface.

17. The apparatus of claim 16, wherein the damping material coating includes a ceramic material.

18. A gas turbine engine comprising:
a rotor;
a stator;
a radial seal segment positioned between the rotor and the stator; and
a damping material coating coupled to a surface of the radial seal segment.

19. The gas turbine engine of claim 18, wherein the surface is a first surface, the radial seal segment including:
a first seal body adjacent the rotor and a second surface of the stator;
a second seal body adjacent a third surface of the stator, the third surface opposite the second surface, the second seal body pivotable relative to the first seal body; and
a pivot bar extending between the first seal body and the second seal body, the pivot bar including the first surface.

20. The gas turbine engine of claim 18, wherein the radial seal segment is a first radial seal segment, further including a second radial seal segment positioned between the rotor and the stator and coupled to the first radial seal segment, the surface corresponding to at least one of a first surface of the first radial seal segment or a second surface of the second radial seal segment, the first surface adjacent the second surface.
